(19) United States
(12) Patent Application Publication
(10) Pub. No.: US 2009/0040907 A1
(43) Pub. Date: Feb. 12, 2009

(54) OPTICAL PICKUP DEVICE AND OPTICAL DISK APPARATUS INCLUDING THE SAME

(75) Inventors: Mikinori MATSUDA, Kanagawa (JP); Hideo Fukumoto, Hyogo (JP); Kotaro Ando, Saitama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/168,388

(22) Filed: Jul. 7, 2008

(30) Foreign Application Priority Data
Aug. 6, 2007 (JP) 2007-204634

(51) Int. Cl. G11B 7/00

(52) U.S. Cl. 369/112.23

(57) ABSTRACT

An optical pickup device includes an objective-lens driving mechanism including a lens holder that holds an objective lens configured to focus a light beam emitted from a light source onto an optical disk, a support unit that movably supports the lens holder in a focusing direction parallel to an optical axis of the objective lens and in a tracking direction perpendicular to the optical axis, and magnets that apply predetermined magnetic fields to coils of the lens holder. The optical pickup device further includes a light source holding unit that fixedly holds the light source, and a yoke member attached to a magnet located at a position near the light source. The light source holding unit and the yoke member are thermally conductive metal. The yoke member extends toward the light source and is fixed to the light source holding unit in a thermally conductive manner.

### CROSS REFERENCES TO RELATED APPLICATIONS

The present invention contains subject matter related to Japanese Patent Application JP 2007-204634 filed in the Japanese Patent Office on Aug. 6, 2007, the entire contents of which are incorporated herein by reference.

### BACKGROUND OF THE INVENTION

1. Field of the Invention

The present invention relates to an optical pickup device that records and/or reproduces an information signal onto and/or from an optical disk, and to an optical disk apparatus including the optical pickup device.

2. Description of the Related Art

Optical disks such as compact discs (CDs) and digital versatile discs (DVD) and optical disks for recording or reproducing a signal using a light beam with a wavelength of about 405 nm emitted from a blue-violet semiconductor laser or any other suitable light source to perform higher-density recording (hereinafter referred to as “high-density recording optical disks”) have been available as recording media designed to record information signals. Optical pickup devices configured to record information signals onto such optical disks or to reproduce information signals recorded on the optical disks have also been available.

An optical pickup device includes a light source that emits a light beam, an objective lens that focuses the light beam emitted from the light source onto a signal recording surface of an optical disk as a light spot, and a light-receiving element that receives a return light beam reflected from the signal recording surface. Those optical components are fixedly attached to a metal or resin pickup base. The optical pickup device further includes an actuator serving as an objective-lens driving mechanism that drives the objective lens in, for example, focusing and tracking directions.

With the recent increased speed of optical pickup devices, high-power laser diodes have been used as light sources to perform recording on recordable optical disks. With the increase in the output power of laser diodes, the amount of heat generated also increases. Inappropriate dissipation of the generated heat might cause an increase in the temperature of lasers, leading to problems such as performance degradation and aging degradation of the lasers.

Demands also exist for the use of resin pickup bases in view of simple manufacturing processes, high productivity, and low cost. In case of using resin pickup bases, because of their lower thermal conductivity than metal pickup bases, it is difficult to dissipate the heat, and the foregoing problems are more likely to occur.

Japanese Unexamined Patent Application Publication No. 2005-353120 is an example of the related art.

### SUMMARY OF THE INVENTION

It is desirable to provide an optical pickup device that allows appropriate heat dissipation without increasing the structural complexity or cost of the device and an optical disk apparatus including the optical pickup device.

According to an embodiment of the present invention, an optical pickup device includes an objective-lens driving mechanism, the objective-lens driving mechanism including a lens holder that holds an objective lens configured to focus a light beam emitted from a light source onto a signal recording surface of a rotating optical disk, the lens holder being configured to be movable in a focusing direction parallel to an optical axis of the objective lens and in a tracking direction perpendicular to the optical axis of the objective lens, the lens holder including coils, a support unit that supports the lens holder so that the lens holder is movable in the focusing direction and the tracking direction, and magnets arranged to apply predetermined magnetic fields to the coils of the lens holder; a light source holding unit that fixedly holds the light source; and a yoke member attached to at least one of the magnets that is located at a position near the light source. Each of the light source holding unit and the yoke member is formed of a metal material having a high thermal conductivity. The yoke member extends toward the light source and is fixed to the light source holding unit in a thermally conductive manner.

According to another embodiment of the present invention, an optical disk apparatus includes drive means for holding an optical disk and driving the optical disk to rotate; and an optical pickup device configured to irradiate the optical disk driven to rotate by the drive means with a light beam to perform at least one of recording and reproduction of an information signal. The optical pickup device includes an objective-lens driving mechanism including a lens holder that holds an objective lens configured to focus a light beam emitted from a light source onto a signal recording surface of the rotating optical disk, the lens holder being configured to be movable in a focusing direction parallel to an optical axis of the objective lens and in a tracking direction perpendicular to the optical axis of the objective lens, the lens holder including coils, a support unit that supports the lens holder so that the lens holder is movable in the focusing direction and the tracking direction, and magnets arranged to apply predetermined magnetic fields to the coils of the lens holder; a light source holding unit that fixedly holds the light source; and a yoke member attached to at least one of the magnets that is located at a position near the light source. Each of the light source holding unit and the yoke member is formed of a metal material having a high thermal conductivity. The yoke member extends toward the light source and is fixed to the light source holding unit in a thermally conductive manner.

Accordingly, each of a light source holding unit that holds a light source serving as a heat generating source, and a yoke member attached to a magnet is formed of a material having a high thermal conductivity. The heat generated by the light source is transferred to the yoke member through the light source holding unit and further to the magnet through the yoke member. Therefore, the heat can be dissipated from the yoke member and the magnet, resulting in appropriate heat dissipation without increasing the structural complexity and cost.

### BRIEF DESCRIPTION OF THE DRAWINGS

FIG. 1 is a schematic block circuit diagram showing an example structure of an optical disk apparatus according to an embodiment of the present invention;

FIG. 2 is a perspective view of an optical pickup device according to an embodiment of the present invention;

FIG. 3 is an exploded perspective view of the optical pickup device according to the embodiment of the present invention;

FIG. 4 is a plan view showing an optical system included in the optical pickup device according to the embodiment of the present invention;

FIG. 5 is a perspective view of a yoke member included in a heat dissipation mechanism of the optical pickup device according to the embodiment of the present invention;

FIG. 6 is a perspective view of a main part including the yoke member and a lens holder, which are included in the heat dissipation mechanism of the optical pickup device according to the embodiment of the present invention; and

FIG. 7 is a perspective view of the optical pickup device, showing the flow of heat transferred using the heat dissipation mechanism of the optical pickup device according to the embodiment of the present invention.

### DESCRIPTION OF THE PREFERRED EMBODIMENTS

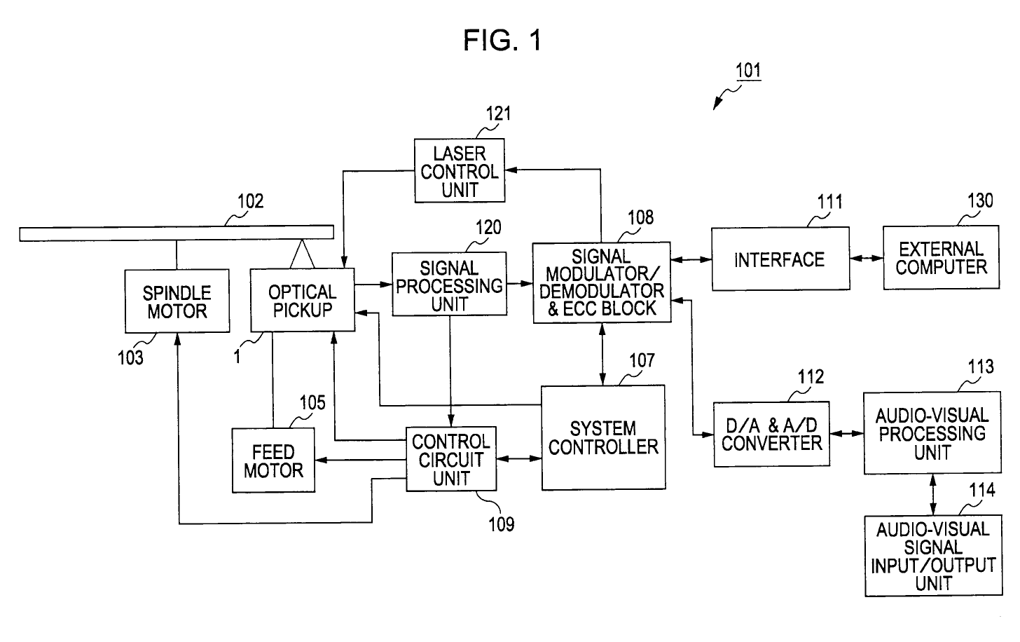

An optical disk apparatus including an optical pickup device according to an embodiment of the present invention will be described with reference to the drawings. Referring to FIG. 1, an optical disk apparatus 101 may be a recording/reproducing apparatus configured to record and/or reproduce an information signal onto and/or from an optical disk 102.

Examples of the optical disk 102 for which recording and/or reproduction is performed using the optical disk apparatus 101 include optical disks, for example, a CD and a DVD, disks on which information is recordable, such as a CD-Recordable (CD-R) and a DVD-Recordable (DVD-R), and disks on which information is rewritable, such as a CD-Rewritable (CD-RW), a DVD-Rewritable (DVD-RW), and a DVD plus Rewritable (DVD+RW). The examples further include optical disks with a shorter emission, which allow high-density recording using a semiconductor laser with a wavelength of about 405 nm (blue-violet wavelength), and magneto-optical disks.

As shown in FIG. 1, the optical disk apparatus 101 includes a spindle motor 103 serving as a drive unit that drives the optical disk 102 to rotate, an optical pickup device 1, and a feed motor 105 serving as a drive unit that drives the optical pickup device 1 to move in the radial direction thereof. The spindle motor 103 is controlled by a system controller 107 and a control circuit unit 109 so as to be driven at a predetermined rotational speed.

A signal modulator/demodulator and error-correction-code (ECC) block 108 modulates and demodulates a signal output from a signal processing unit 120, and adds an error correction code. The optical pickup device 1 irradiates a signal recording surface of the rotating optical disk 102 with a light beam according to an instruction from the system controller 107 and the control circuit unit 109. The optical disk 102 is irradiated with the light beam to thereby record an information signal onto the optical disk 102 and reproduce an information signal recorded on the optical disk 102.

The optical pickup device 1 detects various light beams, which will be described below, based on the light beam reflected from the signal recording surface of the optical disk 102, and supplies detection signals obtained from the light beams to the signal processing unit 120.

The signal processing unit 120 generates various servo signals based on the detection signals obtained by detecting the light beams, namely, a focus error signal and a tracking error signal, and also generates a radio frequency (RF) signal, which is an information signal recorded on an optical disk. Predetermined operations based on those signals, such as demodulation and error correction, are performed by the control circuit unit 109, the signal modulator/demodulator and ECC block 108, and any other suitable unit according to the type of a recording medium to be reproduced.

For example, if a recording signal demodulated by the signal modulator/demodulator and ECC block 108 is a signal for data storage of computers, the recording signal is transmitted to an external computer 130 via an interface 111. The external computer 130 can thus receive the signal recorded on the optical disk 102 as a reproduction signal.

If a recording signal demodulated by the signal modulator/demodulator and ECC block 108 is an audio-visual signal, the recording signal is supplied to a digital-to-analog (D/A) and analog-to-digital (A/D) converter 112. The recording signal is converted from digital to analog form by a D/A conversion unit of the D/A and A/D converter 112, and is then supplied to an audio-visual processing unit 113. The audio-visual processing unit 113 performs audio-video signal processing, and transmits the result to an external imaging and projector products through an audio-visual signal input/output unit 114.

The optical pickup device 1 is connected to the feed motor 105. The optical pickup device 1 is fed in the radial direction of the optical disk 102 by the rotation of the feed motor 105, and is moved to a predetermined recording track on the optical disk 102. The spindle motor 103, the feed motor 105, and an objective-lens driving mechanism 11 (not shown in FIG. 1) are controlled by the control circuit unit 109. The objective-lens driving mechanism 11 drives objective lenses 23 and 24 (not shown in FIG. 1) of the optical pickup device 1 to move in a focusing direction F along an optical axis direction of the objective lenses 23 and 24 and in a tracking direction T perpendicular to the optical axis direction.

The control circuit unit 109 controls the spindle motor 103, and controls the objective-lens driving mechanism 11 according to a focus error signal and a tracking error signal.

The control circuit unit 109 generates a drive signal (drive current) based on the focus error signal, tracking error signal, RF signal, and any other suitable signal input from the signal processing unit 120. The drive signal is supplied to a tracking coil and focusing coil provided on the optical pickup device 1.

A laser control unit 121 controls a laser light source of the optical pickup device 1.

The focusing direction F extends in the optical axis direction of the objective lenses 23 and 24 of the optical pickup device 1. A tangential direction Tz is perpendicular to the focusing direction F and parallel to a tangential direction Tz of the circumference of the optical disk apparatus 101. The tracking direction T is perpendicular to the focusing direction F and the tangential direction Tz.

The optical pickup device 1 according to the embodiment of the present invention will now be described in detail.

The optical pickup device 1 is used for an optical disk apparatus configured to record and/or reproduce information signals onto and/or from a plurality of optical disks 102 onto or from which information signals are recorded or reproduced selectively using a plurality of light beams with different wavelengths. Specifically, the optical pickup device 1 is configured to record and/or reproduce an information signal onto and/or from a first optical disk onto or from which an information signal is recorded or reproduced using a light beam with a first waveform of about 400 nm to about 410 nm, a second optical disk onto or from which an information signal is recorded or reproduced using a light beam with a second waveform of about 650 nm to about 660 nm, and a third optical disk onto or from which an information signal is recorded or reproduced using a light beam with a third waveform of about 760 nm to about 800 nm.

In the following description, the optical pickup device 1 is designed to record and/or reproduce an information signal onto and/or from three different optical disks. Alternatively, by way of example, the optical pickup device 1 may be configured to record and/or reproduce an information signal onto and/or from one type of optical disk or a plurality of different types of optical disks.

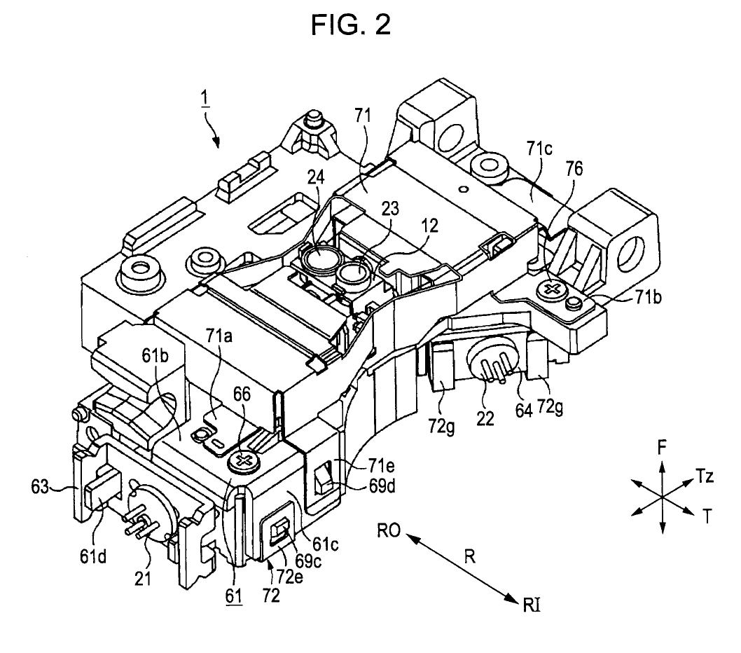

Referring to FIG. 2, the optical pickup device 1 according to the embodiment of the present invention includes first and second light sources 21 and 22, a photodiode, and an optical system. The first and second light sources 21 and 22 include semiconductor lasers that emit a plurality of light beams with the different wavelengths described above. The photodiode serves as a light-detecting element that detects a light beam reflected from the signal recording surface of the optical disk 102. The optical system directs light beams from the first and second light sources 21 and 22 to the optical disk 102, and directs the light beam reflected from the optical disk 102 to the light-detecting element.

The first light source 21 includes an emission unit that emits a light beam with the first wavelength. The second light source 22 includes an emission unit that emits a light beam with the second wavelength, and another emission unit that emits a light beam with the third wavelength.

The optical pickup device 1 is mounted on a pickup base 20 (not shown in FIG. 2) serving as a mounting base on which various components accommodated in a housing of the optical disk apparatus 101 are mounted. The components are movably mounted in a radial direction R of the optical disk 102. In FIG. 2, an arrow RI indicates a radial direction toward the inner circumference of the optical disk 102, and an arrow RO indicates a radial direction toward the outer circumference of the optical disk 102.

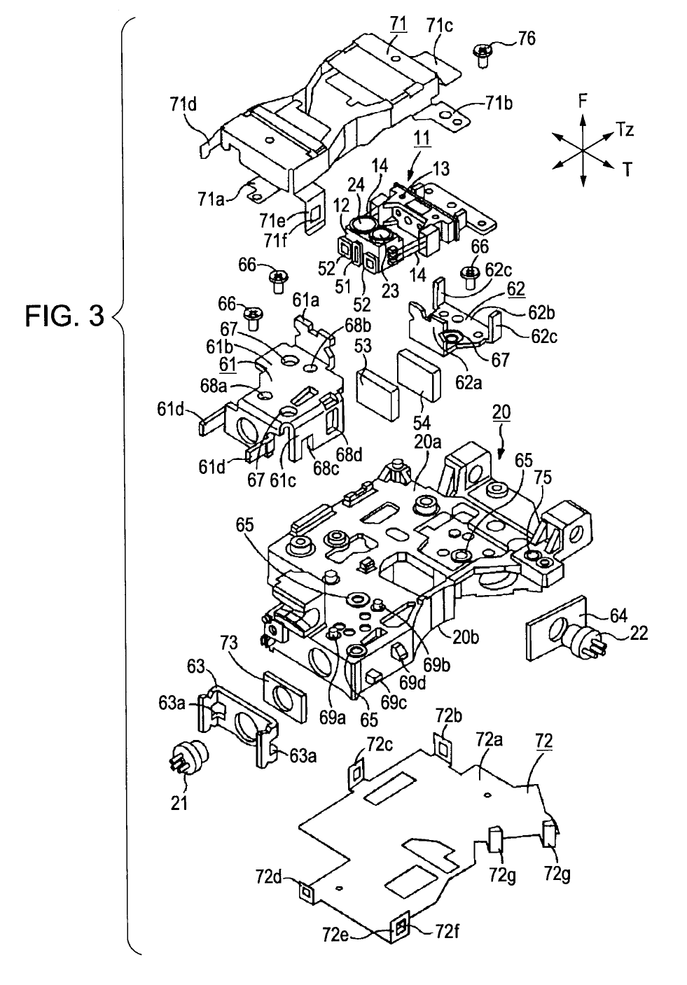

As shown in FIG. 3, the optical pickup device 1 includes a lens holder 12, a support member 13, and a plurality of support arms 14. The lens holder 12 supports the objective lenses 23 and 24 that focus the light beams emitted from the light sources 21 and 22 onto the optical disk 102. The support member 13 is mounted on the pickup base (mounting base) 20 so as to be spaced apart from the lens holder 12 in the tangential direction Tz. The support arms 14 are arranged to movably support the lens holder 12 in the focusing direction F and the tracking direction T with respect to the support member 13. The lens holder 12, the support member 13, and the support arms 14 cooperate with coils 51 and 52 and magnets 53 and 54, which will be described below, to function as the objective-lens driving mechanism 11 that drives the objective lenses 23 and 24 in the focusing direction F and the tracking direction T in a manner described below. That is, the objective-lens driving mechanism 11 includes the lens holder 12 that holds the objective lenses 23 and 24 configured to focus the light beams emitted from the light sources 21 and 22 onto the signal recording surface of the rotating optical disk 102 and that is caused to move in the focusing direction F and the tracking direction T; the support member 13 that movably supports the lens holder 12 in the focusing direction F and the tracking direction T through the support arms 14, which may be a resilient member; and the magnets 53 and 54 arranged to apply predetermined magnetic fields to the coils 51 and 52 provided on the lens holder 12. The first and second objective lenses 23 and 24 constitute a part of the optical system of the optical pickup device 1. In the following description, the first objective lens 23 is composed of, for example, a glass material, and the second objective lens 24 is composed of, for example, a synthetic resin material. However, the first and second objective lenses 23 and 24 may not be necessarily made of the materials described above, and either of the first and second objective lenses 23 and 24 may be composed of a glass material or a synthetic resin material.

In the optical pickup device 1, the plurality of objective lenses 23 and 24 are arranged side-by-side in the radial direction R (the tracking direction T), by way of example. However, the number and arrangement of objective lenses are not limited to those described above. For example, a plurality of objective lenses may be arranged in the tangential direction Tz.

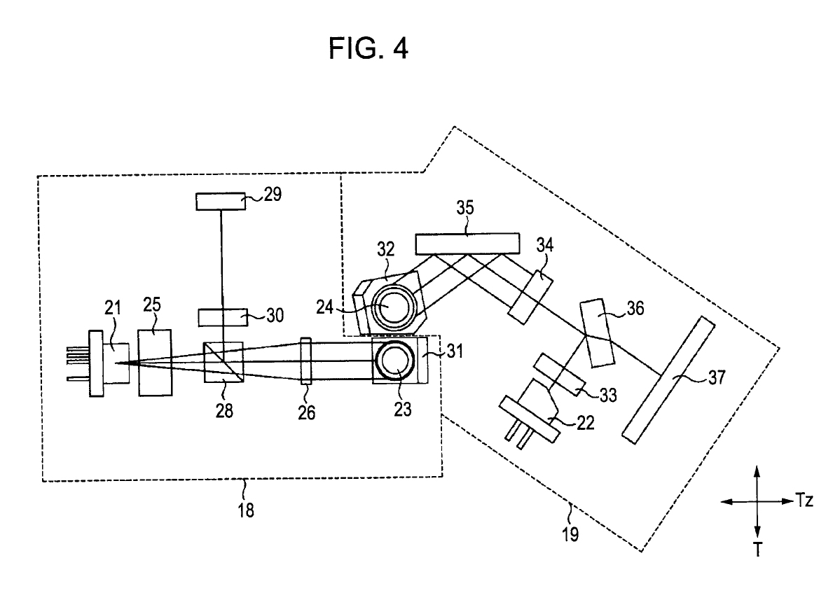

As shown in FIG. 4, the optical system that directs the light beams emitted from the first and second light sources 21 and 22 to the optical disk 102 include first and second optical systems 18 and 19. The first optical system 18 is designed to direct the light beam emitted from the first light source 21 to the optical disk 102, which may be the first optical disk, through the first objective lens 23. The second optical system 19 is designed to direct the light beam emitted from the second light source 22 to the optical disk 102, which may be the second or third optical disk, through the second objective lens 24.

The first optical system 18 at least includes a first grating 25, a first collimator lens 26, a first erected mirror 31, and the first objective lens 23 described above. The first grating 25 diffracts the light beam having the first wavelength emitted from the first light source 21 into at least three beams. The first collimator lens 26 converts the angle of divergence of the light beams obtained by the first grating 25 to produce substantially parallel light. The first erected mirror 31 reflects the light beams converted into substantially parallel light by the first collimator lens 26, and directs the reflected light beams toward the first objective lens 23 and the optical disk 102. The first objective lens 23 focuses the light beams emitted from the first erected mirror 31 onto the signal recording surface of the optical disk 102. The first optical system 18 further includes a polarized light beam splitter 28, a first light detector 29, and a multi-lens unit 30. The polarized light beam splitter 28 is provided between the first grating 25 and the first collimator lens 26 to separate an optical path of a return light beam that has been focused by the first objective lens 23 and that has been reflected from the optical disk 102 from an optical path of the outgoing light beam emitted from the first light source 21. The first light detector 29 receives and detects the return light beam separated by the polarized light beam splitter 28. The multi-lens unit 30 is provided between the polarized light beam splitter 28 and the first light detector 29 to focus the return light beam separated by the polarized light beam splitter 28 onto a light-receiving surface of the first light detector 29.

The second optical system 19 at least includes a second grating 33, a second collimator lens 34, a folding mirror 35, a second erected mirror 32, and the second objective lens 24 described above. The second grating 33 diffracts each of the light beams with the second and third wavelengths emitted from the second light source 22 into at least three beams. The second collimator lens 34 converts the angle of divergence of the light beams obtained by the second grating 33 to produce substantially parallel light. The folding mirror 35 reflects the light beams converted into substantially parallel light by the second collimator lens 34, and changes the optical paths of the light beams on a plane substantially perpendicular to the focusing direction F. The second erected mirror 32 reflects the light beams emitted from the folding mirror 35, and directs the reflected light beams toward the second objective lens 24 and the optical disk 102. The second objective lens 24 focuses the light beams emitted from the second erected mirror 32 onto the signal recording surface of the optical disk 102. The second optical system 19 further includes a beam splitter 36 and a second light detector 37. The beam splitter 36 is provided on an optical path between the second grating 33 and the second collimator lens 34 to separate an optical path of a return light beam that has been focused by the second objective lens 24 and that has been reflected by the optical disk 102 from an optical path of the outgoing light beam emitted from the second light source 22. The second light detector 37 receives and detects the return light beam separated by the beam splitter 36.

The lens holder 12 that holds the objective lenses 23 and 24 described above is provided with a tracking coil 51 and focusing coils 52. The tracking coil 51 is arranged to generate a driving force in the tracking direction T, which may be substantially equal to the radial direction R of the optical disk 102. The focusing coils 52 are arranged to generate a driving force in the focusing direction F, which may be a direction approaching and retracting from the optical disk 102. The pickup base 20 has yoke members 61 and 62 mounted thereon, over which the lens holder 12 is provided. The yoke members 61 and 62 are arranged so as to sandwich the lens holder 12 therebetween, and a pair of yoke pieces 61a and 62a are erected so as to face each other with the first and second objective lenses 23 and 24 therebetween. A pair of magnets 53 and 54 are mounted on opposing surfaces of the yoke pieces 61a and 62a, respectively. The pair of magnets 53 and 54 are arranged so as to face the tracking coil 51 and the focusing coils 52, and are designed to apply predetermined magnetic fields to the tracking coil 51 and the focusing coils 52.

When a driving electric current is fed to the tracking coil 51 and the focusing coils 52, the electric current fed to the coils 51 and 52 and the magnetic fields generated from the magnets 53 and 54 interact to displace the lens holder 12 in the tracking direction T and the focusing direction F.

As a result, the first and second objective lenses 23 and 24 supported by the lens holder 12 are displaced in the focusing direction F and/or the tracking direction T, and focus control is thus performed. That is, the light beam with which the optical disk 102 is irradiated through the first and second objective lenses 23 and 24 is controlled so as to be focused onto the signal recording surface of the optical disk 102. Tracking control is also performed. That is, the light beam is controlled so as to trace a recording track formed on the optical disk 102. In this embodiment, the tracking coil 51, the focusing coils 52, and the magnets 53 and 54 adapted to apply magnetic fields to the tracking coil 51 and the focusing coils 52 are provided. Alternatively, for example, a tilt coil and a magnet used for the tilt coil may be arranged to cause the lens holder 12 and the objective lenses 23 and 24 held by the lens holder 12 to be tilted around the axis of the tracking direction T, called a radial tilt direction, or around the axis of the tangential direction Tz, called a tangential tilt direction, and various types of tilt control may be performed.

The optical pickup device 1 having the structure described above is configured such that, depending on the type of the optical disk 102 placed thereon, a light beam with a wavelength corresponding to the type of the optical disk 102 among the first to third wavelengths is emitted from the emission unit of one of the first and second light sources 21 and 22 to perform focus control and tracking control so that the light beam irradiated through an objective lens corresponding to the type of the optical disk 102 among the first and second objective lenses 23 and 24 can be focused and tracked on a predetermined recording track, thereby performing recording or reproduction of an information signal onto or from the optical disk 102.

The optical pickup device 1 according to the embodiment of the present invention is provided with a heat dissipation mechanism that allows appropriate heat dissipation in order to solve a problem of performance degradation and aging degradation of a laser due to an increased temperature of the laser, which may be caused by the heat generated by the light sources 21 and 22 and any other component. The heat dissipation mechanism of the optical pickup device 1 will now be described.

Referring to FIG. 3, the heat dissipation mechanism of the optical pickup device 1 includes a laser holder 63 serving as a light source holding unit that fixedly holds the first light source 21, a laser holder 64 serving as a light source holding unit that fixedly holds the second light source 22, and the yoke members 61 and 62 attached to the magnets 53 and 54, described above, respectively. In the optical pickup device 1, the yoke member 61 attached to the magnet 53 and the yoke member 62 attached to the magnet 54 are separately provided. However, the yoke members 61 and 62 may be integrated into a single yoke member.

In the optical pickup device 1, it is important to appropriately dissipate the heat generated by the first light source 21 located at an end of the optical pickup device 1. The laser holder 63 and the yoke member 61 constitute a heat dissipation mechanism configured to dissipate the heat generated by the first light source 21, which is difficult to dissipate. The laser holder 63 that fixedly holds the light source 21 located at a position apart from the magnets 53 and 54, and the yoke member 61 attached to the magnet 53, which is located at a position near the light source 21, provide the ability to dissipate the heat generated by the light source 21. The dissipation of the heat will now be described.

The yoke member 61 located at the position near the light source 21 extends toward the light source 21 located at the position apart from the magnets 53 and 54, and is fixed to the laser holder 63 in a thermally conductive manner.

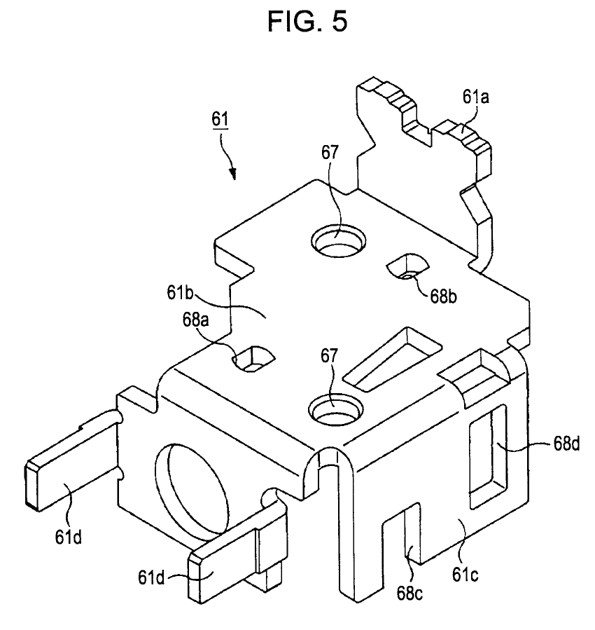

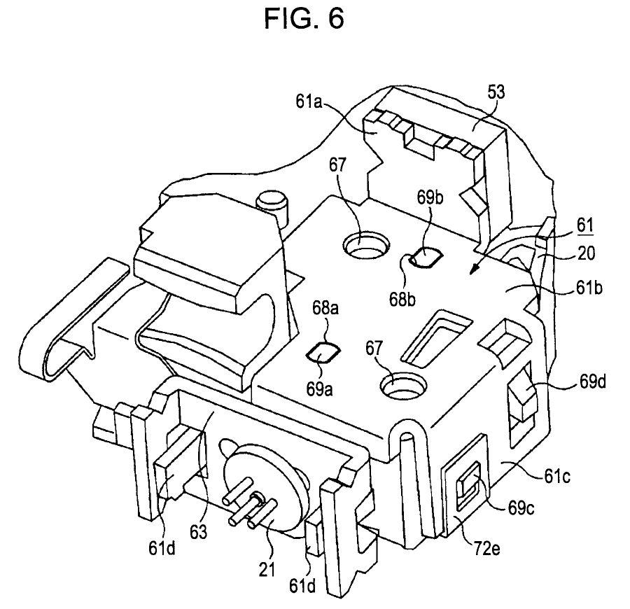

As shown in FIGS. 5 and 6, the yoke member 61 includes the yoke piece 61a described above, a first extending portion 61b, a second extending portion 61c, and fixing portions 61d. The yoke piece 61a functions as a mounting portion on which the magnet 53 is mounted. The first extending portion 61b extends toward the light source 21 from the yoke piece 61a so as to be substantially parallel to the optical disk 102, and is formed to face the optical disk 102. The second extending portion 61c further extends from the first extending portion 61b so as to be substantially perpendicular to the first extending portion 61b, and is formed so as to cover a portion of a side surface of the pickup base 20. The fixing portions 61d are connected to the laser holder 63 to fix the laser holder 63.

The yoke member 61 is fixed to the pickup base 20 by placing the yoke member 61 on a principal surface 20a of the pickup base 20 and then inserting set screws 66 through threaded holes 67 formed in the first extending portion 61b and threaded holes 65 formed in the pickup base 20. The fixing portions 61d of the yoke member 61 are fixed to the laser holder 63 in a thermally conductive manner using a technique such as soldering in such a manner that the fixing portions 61d are inserted through through-holes 63a formed in the laser holder 63. A heat dissipation sheet 73 is held between the laser holder 63 and the yoke member 61. The first extending portion 61b of the yoke member 61 has engagement portions 68a to 68d formed therein for positioning, and engagement projecting portions 69a to 69d corresponding to the engagement portions 68a to 68d are provided on the pickup base 20.

Accordingly, the yoke member 61 has the first extending portion 61b that extends to be connected to the light source 21, and is fixed, in a thermally conductive manner, to the laser holder 63 that directly holds the light source 21 through the fixing portions 61d. Since the light source 21 and the laser holder 63 are attached to the yoke member 61 at predetermined positions and the yoke member 61 is formed of a material having a high thermal conductivity, the yoke member 61 serves to absorb the heat of the light source 21 serving as a heat generating source. Heat is transferred to the yoke member 61 not only from the laser holder 63 through the fixing portions 61d and but also through the heat dissipation sheet 73.

The extending portion 61b of the yoke member 61 extends toward the light source 21 and is thus formed in a continuous manner to the laser holder 63, which holds the light source 21, through the heat dissipation sheet 73. Heat can thus be transferred from the light source 21 and the laser holder 63. The fixing portions 61d, which are positioned at a leading end of the extending portion 61b so as to be integrally formed therewith, are fixed to the laser holder 63 in direct contact therewith using a technique such as soldering. Since materials having a high thermal conductivity are in direct contact with each other, the fixing portions 61d are connected to the laser holder 63 in a high thermal conductive state and the heat can be efficiently transferred to the fixing portions 61d from the light source 21 and the laser holder 63.

The yoke member 61 also serves to transfer the heat from the light source 21 serving as a heat generating source to the magnet 53, an upper-side cover member 71, and a lower-side cover member 72 in a manner described below to dissipate the heat. The heat can also be dissipated from the first and second extending portions 61b and 61c, which are integrally formed on the yoke member 61, and the yoke piece 61a.

Since the first extending portion 61b provided on the yoke member 61 is provided substantially parallel to the optical disk 102 so as to face the optical disk 102, the heat generated by the light source 21 serving as a heat generating source is cooled by the flow of air caused by the rotation of the optical disk 102 during the recording and reproduction of the optical disk apparatus 101 during which the light source 21 generates heat. Therefore, the heat generated by the light source 21 can be more efficiently dissipated.

The yoke member 62 includes the yoke piece 62a described above, a third extending portion 62b, and erected pieces 62c. The yoke piece 62a functions as a mounting portion on which the magnet 54 is mounted. The third extending portion 62b extends from the yoke piece 62a in a direction opposite to the direction in which the first extending portion 61b of the yoke member 61 extends. The erected pieces 62c are erected from the third extending portion 62b.

The yoke member 62 is fixed to the pickup base 20 by placing the yoke member 62 on the principal surface 20a of the pickup base 20 and then inserting a set screw 66 through a threaded hole 67 formed in the third extending portion 62b and a threaded hole 65 formed in the pickup base 20. The erected pieces 62c of the yoke member 62 come into contact with the upper-side cover member 71, which will be described below, in a thermally conductive manner. As described below, the yoke member 62 absorbs the heat transferred to the upper-side cover member 71, and transfers the heat to the magnet 54 to thereby dissipate the heat. The heat can also be dissipated from the yoke member 62.

The heat dissipation mechanism of the optical pickup device 1 further includes the upper-side cover member 71 and the lower-side cover member 72. The upper-side cover member 71 is mounted over the principal surface 20a of the pickup base 20 that faces the optical disk 102 (hereinafter also referred to as “upper-side principal surface”), and is defined so as to cover the objective-lens driving mechanism 11. The lower-side cover member 72 is mounted over a principal surface 20b of the pickup base 20 that is on a side opposite to the principal surface 20a facing the optical disk 102 (hereinafter also referred to as a “lower-side principal surface”), and is defined so as to cover optical components located on the lower side of the pickup base 20 and the bottom surface of the pickup base 20.

For example, the upper-side cover member 71 may be made of a metal material, i.e., a material having a high thermal conductivity, and serves as a driving-mechanism covering member that covers an optical-disk side of the objective-lens driving mechanism 11.

The upper-side cover member 71 includes a plurality of mounting pieces 71a to 71e. The upper-side cover member 71 is fixed to the pickup base 20 by bringing the plurality of mounting pieces 71a to 71e into abutment against the pickup base 20 and then inserting a set screw 76 into a threaded hole formed in the mounting piece 71b and a threaded hole 75 corresponding thereto, which is formed in the pickup base 20. The upper-side cover member 71 is provided with an engagement portion 71f, for positioning, at the mounting piece 71e provided on a side portion of the upper-side cover member 71, which is near the light source 21. The engagement portion 71f is engaged with the engagement projecting portion 69d provided on the pickup base 20. Thus, the upper-side cover member 71 is attached to the first extending portion 61b of the yoke member 61 described above in contact therewith in a thermally conductive manner through the mounting piece 71a, and is also attached to the second extending portion 61c of the yoke member 61 described above in contact therewith in a thermally conductive manner through the mounting piece 71e. The heat generated by the light source 21 is transferred to the upper-side cover member 71 through the laser holder 63 and the fixing portions 61d and first and second extending portions 61b and 61c of the yoke member 61, thereby dissipating the heat from the upper-side cover member 71.

Due to its structure, the upper-side cover member 71 is provided substantially parallel to the optical disk 102 so as to face the optical disk 102. As with the first extending portion 61b described above, the heat generated by the light source 21 serving as a heat generating source is cooled by the flow of air caused by the rotation of the optical disk 102 during the recording and reproduction of the optical disk apparatus 101 during which the light source 21 generates heat. Thus, the heat can be more efficiently dissipated.

For example, the lower-side cover member 72 may be made of a metal material, i.e., a material having a high thermal conductivity, and serves as a base covering member that covers a surface opposite to a surface of the pickup base 20 on which the objective-lens driving mechanism 11 is provided.

The lower-side cover member 72 includes a plurality of mounting pieces 72b to 72e. The plurality of mounting pieces 72b to 72e are brought into abutment against the pickup base 20 to fix the lower-side cover member 72 to the pickup base 20. The lower-side cover member 72 is provided with an engagement portion 72f, for positioning, at the mounting piece 72e provided on a side portion of the lower-side cover member 72, which is near the light source 21. The engagement portion 72f is engaged with the engagement projecting portion 69c provided on the pickup base 20. Thus, the lower-side cover member 72 is attached to the second extending portion 61c of the yoke member 61 described above in contact therewith in a thermally conductive manner through the mounting piece 72e. The heat generated by the light source 21 is transferred to the lower-side cover member 72 through the laser holder 63 and the fixing portions 61d and first and second extending portions 61b and 61c of the yoke member 61, thereby dissipating the heat from the lower-side cover member 72.

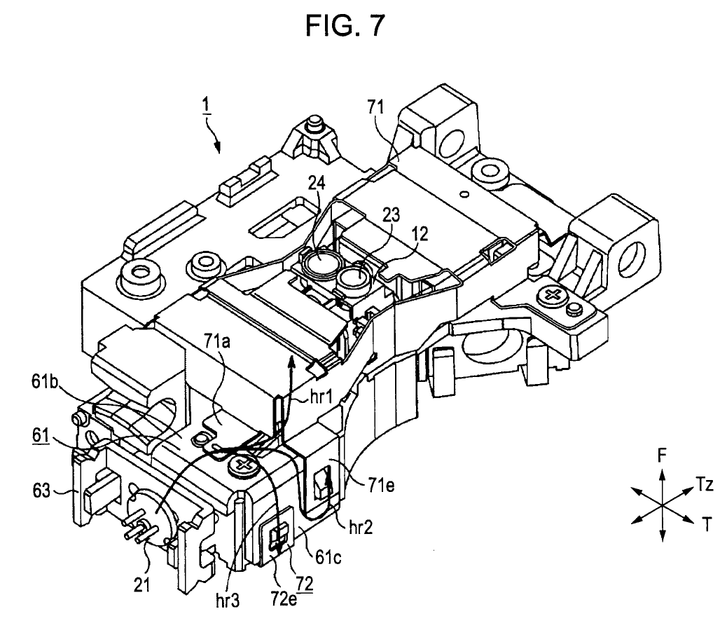

In the optical pickup device 1, therefore, the laser holder 63, the yoke member 61, the upper-side cover member 71, and the lower-side cover member 72 are adapted to provide appropriate heat dissipation. That is, as shown in FIG. 7, the heat generated by the first light source 21 is transferred to the magnet 53 via a first heat dissipation path hr1 passing through the laser holder 63, the first extending portion 61b, the yoke piece 61a, and the magnet 53, and is appropriately dissipated from the magnet 53 and the first heat dissipation path hr1. The heat generated by the first light source 21 is also transferred to the upper-side cover member 71, which may be metal, via a second heat dissipation path hr2 passing through the laser holder 63, the first extending portion 61b, the second extending portion 61c, and the upper-side cover member 71, and is appropriately dissipated from the upper-side cover member 71 and the second heat dissipation path hr2. The heat generated by the first light source 21 is also transferred to the lower-side cover member 72, which may be metal, via a third heat dissipation path hr3 passing through the laser holder 63, the first extending portion 61b, the second extending portion 61c, and the lower-side cover member 72, and is appropriately dissipated from the lower-side cover member 72 and the third heat dissipation path hr3.

While a configuration for dissipating the heat generated by the light source 21 has been described, the optical pickup device 1 is also configured to appropriately dissipate the heat generated by the light source 22. The laser holder 64 and the lower-side cover member 72 form a heat dissipation mechanism for dissipating the heat generated by the light source 22.

The lower-side cover member 72 described above is provided with erected pieces 72g at portions corresponding to the position of the light source 22. The lower-side cover member 72 is attached in contact with the laser holder 64 that holds the light source 22 through the erected pieces 72g in a thermally conductive manner, thus providing absorption of the heat generated by the light source 22 serving as a heat generating source. The heat generated by the light source 22 can thus be dissipated through the lower-side cover member 72 and also through the yoke member 61 and upper-side cover member 71 to which the heat can be transferred.

Furthermore, the upper-side cover member 71 and lower-side cover member 72, which form the heat dissipation mechanism described above, ensure appropriate heat dissipation to protect the optical components from being displaced. The upper-side cover member 71 and the lower-side cover member 72 are also adapted to protect the optical components mounted thereon from being damaged or displaced by the optical components coming into contact with other components or the like during handling or during mounting of the optical pickup device 1 onto the optical disk apparatus 101 to thereby protect the optical components, for which high-precision positioning is demanded.

Accordingly, the upper-side cover member 71 and the lower-side cover member 72 are designed to protect the optical components, which are mounted in a mounting recess of the pickup base 20 so as to be exposed to outside of the pickup base 20, from the risk of being damaged or displaced due to the contact with other components or from the risk of dust. Due to their addition to the structure including the yoke member 61 described above, the upper-side cover member 71 and the lower-side cover member 72 ensure protection of the optical components with a higher heat dissipation effect to thereby protect the optical components mounted on the pickup base 20, which may be resin, from being displaced or the like.

The optical pickup device 1 having the structure described above is configured to appropriately dissipate the heat generated by the light sources 21 and 22 serving as heat generating sources to overcome the problem of performance degradation and aging degradation deterioration of lasers due to an increased temperature of the lasers. In particular, the heat generated by the first light source 21, which has been difficult to dissipate, can be dissipated using the heat dissipation arrangement provided at the end of the pickup base 20. In general, an optical pickup device is configured such that an objective lens held by an objective-lens driving mechanism is located substantially at a center of a flat surface of a pickup base, and it is optically effective to provide a substantially linear optical path in the flat surface extending from a light source to the objective lens. Therefore, the heat dissipation mechanism described above capable of appropriately dissipating the heat generated by the light source 21 in the optical pickup device 1 is effective. While the optical pickup device 1 according to the embodiment of the present invention includes the light sources 21 and 22, the present invention is not limited to this embodiment. For example, in some embodiments of the present invention, an optical pickup device may include an optical system that uses a light beam with a single wavelength, or an optical pickup device may include an optical system that includes a single light source unit having emission units configured to emit light beams with a plurality of wavelengths.

Accordingly, the optical pickup device 1 according to the embodiment of the present invention includes the objective-lens driving mechanism 11 that includes the lens holder 12, the support member 13, and the magnets 53 and 54; the laser holder 63 serving as a light source holding unit that fixedly holds the light source 21 located at an end in a flat surface of the pickup base 20, which is located apart from the objective-lens driving mechanism 11; and the yoke member 61 attached to the magnet 53 located at a position near the light source 21. Each of the laser holder 63 and the yoke member 61 is formed of a metal material having a high thermal conductivity. The yoke member 61 extends toward the light source 21 and is fixed to the laser holder 63 in a thermally conductive manner. The yoke member 61 forming the objective-lens driving mechanism 11 that drives the objective lenses 23 and 24 is formed so as to extend and is connected to the laser holder 63 that holds the light source 21 so that the heat generated by the first light source 21, which is located at a position apart from the objective lenses 23 and 24, can be transferred to the laser holder 63. Thus, the generated heat can be transferred to the magnet 53 through the yoke member 61 and can be dissipated from the magnet 53. The heat can also be dissipated from the extending yoke member 61, resulting in efficient heat dissipation with a simple structure without increasing the structural complexity or cost.

In the optical pickup device 1 according to the embodiment of the present invention, the first extending portion 61b of the yoke member 61, which extends toward the light source 21, is provided substantially parallel to the optical disk 102 so as to face the optical disk 102. Thus, the heat generated by the light source 21 can be more efficiently cooled by the flow of air caused by the rotation of the optical disk 102, and can therefore be efficiently dissipated.

In the optical pickup device 1 according to the embodiment of the present invention, the second extending portion 61c that extends substantially perpendicular to the first extending portion 61b is provided. The heat dissipation effect is increased by an amount corresponding to the volume of the first and second extending portions 61b and 61c, and efficient dissipation of the generated heat is achieved.

The optical pickup device 1 according to the present invention further includes the lower-side cover member 72, which may be metal, serving as a base covering member that covers a surface opposite to a surface of the pickup base 20 on which the objective-lens driving mechanism 11 is mounted. The lower-side cover member 72 is fixed to the first extending portion 61b of the yoke member 61 in a thermally conductive manner, and is also fixed to the second extending portion 61c of the yoke member 61 in a thermally conductive manner. Therefore, the heat generated by the light source 21 can be transferred to the lower-side cover member 72 through the first extending portion 61b, and can be dissipated from the lower-side cover member 72, resulting in efficient heat dissipation.

The optical pickup device 1 according to the embodiment of the present invention further includes the upper-side cover member 71, which may be metal, serving as a driving-mechanism covering member provided near the optical disk 102 and arranged to cover the objective-lens driving mechanism 11, and the upper-side cover member 71 is fixed to the second extending portion 61c of the yoke member 61 in a thermally conductive manner. Thus, the heat generated by the light source 21 can be transferred to the upper-side cover member 71 through the second extending portion 61c, and can be dissipated from the upper-side cover member 71, resulting in efficient heat dissipation.

The optical pickup device 1 according to the embodiment of the present invention further includes the laser holder 64, and the erected pieces 72g of the lower-side cover member 72 are attached in contact in such a manner that heat can be transferred to the laser holder 64. The heat generated by the second light source 22, which is another heat generating source, can be dissipated from the lower-side cover member 72 and also from the yoke member 61 and upper-side cover member 71 to which the heat can be transferred. Thus, the heat generated by the second light source 22, as well as the heat generated by the first light source 21, can be efficiently dissipated with a simple structure.

In the foregoing description, the optical pickup device 1 includes the light source 21 that emits a light beam with the first wavelength and the light source 22 that emits light beams with the second and third wavelengths, which is located at a different position from that of the light source 21. However, a structure of dissipating heat according to an embodiment of the present invention is not limited to a structure including two light sources. For example, an optical pickup device including, at a position corresponding to that of the light source 21, a light source that emits a light beam with a single wavelength or light beams with a plurality of wavelengths would achieve similar advantages as those described above.

The optical disk apparatus 101 according to the embodiment of the present invention includes a drive unit configured to drive an optical disk to rotate, and an optical pickup device including the objective-lens driving mechanism 11 and configured to irradiate the optical disk driven to rotate by the drive unit with a light beam to record and/or reproduce a driving signal. This optical pickup device may be implemented by the optical pickup device 1 described above, thus providing appropriate heat dissipation without increasing the structural complexity and cost. This also protects optical components from being displaced or the like to achieve high-precision positioning of the optical components, resulting in excellent recording and reproduction characteristics.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup device comprising:
an objective-lens driving mechanism, the objective-lens driving mechanism including
a lens holder that holds an objective lens configured to focus a light beam emitted from a light source onto a signal recording surface of a rotating optical disk, the lens holder being configured to be movable in a focusing direction parallel to an optical axis of the objective lens and in a tracking direction perpendicular to the optical axis of the objective lens, the lens holder including coils,
a support unit that supports the lens holder so that the lens holder is movable in the focusing direction and the tracking direction, and
magnets arranged to apply predetermined magnetic fields to the coils of the lens holder;
a light source holding unit that fixedly holds the light source; and
a yoke member attached to at least one of the magnets that is located at a position near the light source,
wherein each of the light source holding unit and the yoke member is formed of a metal material having a high thermal conductivity, and
wherein the yoke member extends toward the light source and is fixed to the light source holding unit in a thermally conductive manner.

2. The optical pickup device according to claim 1, wherein the yoke member includes an extending portion that extends toward the light source, and the extending portion is provided substantially parallel to the optical disk so as to face the optical disk.

3. The optical pickup device according to claim 2, wherein the yoke member further includes a second extending portion that extends substantially perpendicular to the extending portion.

4. The optical pickup device according to claim 3, further comprising:
a pickup base on which the objective-lens driving mechanism, the yoke member, and the light source holding unit are mounted; and
a base covering member that covers a surface opposite to a surface of the pickup base on which the objective-lens driving mechanism is mounted, the base covering member being formed of a metal material,
wherein the base covering member is fixed to the second extending portion in a thermally conductive manner.

5. The optical pickup device according to claim 1, further comprising a driving-mechanism covering member provided near the optical disk and arranged to cover the objective-lens driving mechanism, the driving-mechanism covering member being formed of a metal material,
wherein the driving-mechanism covering member is fixed to the yoke member in a thermally conductive manner.

6. The optical pickup device according to claim 1, further comprising a pickup base on which the objective-lens driving mechanism, the yoke member, and the light source holding unit are mounted, and
wherein the pickup base is formed of a molded resin material.

7. An optical disk apparatus comprising:
drive means for holding an optical disk and driving the optical disk to rotate; and
an optical pickup device configured to irradiate the optical disk driven to rotate by the drive means with a light beam to perform at least one of recording and reproduction of an information signal, the optical pickup device including
an objective-lens driving mechanism including
a lens holder that holds an objective lens configured to focus a light beam emitted from a light source onto a signal recording surface of the rotating optical disk, the lens holder being configured to be movable in a focusing direction parallel to an optical axis of the objective lens and in a tracking direction perpendicular to the optical axis of the objective lens, the lens holder including coils,
a support unit that supports the lens holder so that the lens holder is movable in the focusing direction and the tracking direction, and
magnets arranged to apply predetermined magnetic fields to the coils of the lens holder,
a light source holding unit that fixedly holds the light source, and
a yoke member attached to at least one of the magnets that is located at a position near the light source,
wherein each of the light source holding unit and the yoke member is formed of a metal material having a high thermal conductivity, and
wherein the yoke member extends toward the light source and is fixed to the light source holding unit in a thermally conductive manner.

8. An optical disk apparatus comprising:
a drive unit configured to hold an optical disk and drive the optical disk to rotate; and
an optical pickup device configured to irradiate the optical disk driven to rotate by the drive unit with a light beam to perform at least one of recording and reproduction of an information signal, the optical pickup device including
an objective-lens driving mechanism including
a lens holder that holds an objective lens configured to focus a light beam emitted from a light source onto a signal recording surface of the rotating optical disk, the lens holder being configured to be movable in a focusing direction parallel to an optical axis of the objective lens and in a tracking direction perpendicular to the optical axis of the objective lens, the lens holder including coils,
a support unit that supports the lens holder so that the lens holder is movable in the focusing direction and the tracking direction, and
magnets arranged to apply predetermined magnetic fields to the coils of the lens holder,
a light source holding unit that fixedly holds the light source, and
a yoke member attached to at least one of the magnets that is located at a position near the light source,
wherein each of the light source holding unit and the yoke member is formed of a metal material having a high thermal conductivity, and
wherein the yoke member extends toward the light source and is fixed to the light source holding unit in a thermally conductive manner.
